(19) United States
(12) Patent Application Publication
(10) Pub. No.: US 2009/0136729 A1
(43) Pub. Date: May 28, 2009

(54) Method of forming brilliant multi-layered coating film

(75) Inventors: Hironori Tonomura, Aichi (JP); Yoshizumi Matsuno, Aichi (JP); Yasushi Nakao, Aichi (JP)

Correspondence Address: WENDEROTH, LIND & PONACK, L.L.P., 1030 15th Street, N.W.,, Suite 400 East, Washington, DC, 20005-1503, US

(73) Assignee: Kansai Paint Co., Ltd.

(21) Appl. No.: 11/991,281

(22) PCT Filed: Aug. 29, 2006
(86) PCT No.: PCT/JP2006/317411

§ 371 Date: Feb. 29, 2008

(30) Foreign Application Priority Data
Aug. 30, 2005 (JP) 2005-250354

(51) Int. Cl. B05D 5/06; B05D 7/00

(52) U.S. Cl. 428/218; 427/372.2; 427/385.5; 427/457

(57) ABSTRACT

This invention provides a method for forming brilliant multi-layered coating film excelling in brilliance, which comprises the steps of applying an effect pigment-containing, water-borne base coating composition (A1) containing inorganic fine particles having an average primary particle diameter not more than 1 μm and having a solid content of at least 15 mass % but less than 45 mass % onto a substrate to form a first base coating film; successively applying onto the first base coating film an effect pigment-containing, water-borne base coating composition (A2) having a solid content of at least 5 mass % but less than 15 mass %; and curing the two coating films by heating.

### TECHNICAL FIELD

This invention relates to a coating method of effect pigment-containing, water-borne base coating compositions which are used for coating automobiles and the like. In particular, the invention relates to a method for forming multi-layered coating film having excellent brilliance.

### BACKGROUND ART

Top coating compositions to coat outer panels of automobiles are required to provide top coating film exhibiting color appearance of high grade. To meet this demand, effect pigment-containing base coating compositions are developed.

Base coating compositions in general are for forming underlayer part coating film where the top coating film is composed of multi-layers of coating films. By forming a multi-layered film by applying a transparent clear coating film on a base coating film formed of such a base coating composition, a top coating film exhibiting color appearance of high grade can be obtained, which has both excellent color appearance attributable to the base coating film and superb gloss and surface smoothness attributable to the clear coating film.

Effect pigment normally has laminar or flaky structure and is oriented in the coating film in parallel with the substrate surface to glitter brightly and change color tone according to viewing directions, whereby forming a coating film of unique color appearance. Of such properties, the one of changing the color tone according to change in viewing directions is referred to flip-flop property (FF property), greater changes in color tone signifying higher flip-flop property and better brilliance of the coating film containing the effect pigment.

Conventionally, organic solvent-based base coating compositions have been widely used for effect pigment-containing base coating compositions. Recently, however, water-borne base coating compositions causing less environmental pollution are increasingly adopted, due to environmental pollution with volatilization of the organic solvent during baking of applied coating film. Whereas, it is more difficult to obtain stable appearance with water-borne base coating compositions as compared with organic solvent-based base coating compositions, because of low volatilization rate of water, which is the diluent, from their coating films and, furthermore, because the volatilization rate is significantly affected by ambient application conditions, in particular, temperature and humidity. Thus, coating films of water-borne base coating compositions are subject to the problem that degradation in brilliance is apt to be invited by decrease in flip-flop property or occurrence of unevenness in metallic finish.

In industrial coating lines, normally the work is separately conducted for each zone using a same kind of coating composition, whereby to control degradation in coating quality caused by scattered coating composition's sticking on the substrate or coated film. For example, an automobile coating line is generally divided into undercoating zone, intermediate coating zone, base coating zone and clear coating zone.

Also within each of such coating zones, normally the coating operation is divided into two or more steps and a setting time of from about 30 seconds to 3 minutes is provided between the steps to prevent sagging of coating composition and secure high coating quality. Such coating steps within a same zone are referred to, by the order of being conducted, as the first stage, second stage, and so on.

In the recent years, as one of the means for obtaining coated articles with coating film of high brilliance using water-borne base coating compositions inducing less environmental pollution, a coating method is proposed in which different specific effect pigment-containing, water-borne base coating compositions are used for the first and second stages at a base coating zone.

For example, JP2004-351389A discloses a coating film-forming method comprising applying a water-borne first brilliant base coating composition having a solid content of 10-45 mass % in the first stage of the base coating zone to form a first base coating film; and applying in the second stage a water-borne second brilliant base coating composition having a solid content of 10-40 mass % on the first base coating film to form a second base coating film, the ratio between the solid contents of the water-borne first brilliant base coating composition and the water-borne second brilliant base coating composition being 1.1/1-4/1. However, this coating film-forming method is subject to a problem that layer-mingling takes place at the interface of the coating films in the occasion of forming the second base coating film on the first base coating film at the second stage, presumably due to the difference in solid content of the two coating films, which disturbs orientation of the effect pigments in the vicinity of the interface and occasionally degrade the brilliance.

Also JP 2004-351390A discloses a coating film-forming method comprising forming a first base coating film with a water-borne first brilliant base coating composition in which the mass concentration of effect pigment in the composition is 1-30%, in the first stage of the base coating zone, and forming in the second stage a second base coating film with a water-borne second brilliant base coating composition in which the mass concentration of effect pigment in the composition is 5-40%, the ratio between the mass concentration of effect pigment in the water-borne first brilliant base coating composition and that in the water-borne second brilliant base coating composition being 1/4-1/1.1.

However, this coating film-forming method is subject to a problem that orientation of the effect pigment in the second base coating film is disturbed to reduce brilliance or the second base coating film tends to become relatively brittle and occasionally comes off, because of the high mass concentration of the effect pigment in the second base coating film.

Furthermore, JP2004-351391A discloses a coating film-forming method comprising forming a water-borne first base coating film with a water-borne first brilliant base coating composition in the first stage of the base coating zone, the mass ratio in the solvent of said composition being: organic solvent/water=5/95-49/51, said organic solvent containing 40-100 mass % of a specific organic solvent which has an evaporation rate of 150-800 (where the evaporation rate of n-butyl acetate at 25° C. is set to be 100) and a solubility parameter of 9.5-14.5, and then forming in the second stage a water-borne second base coating film with a water-borne second brilliant base coating composition. This coating film-forming method, however, is liable to induce environmental pollution because a larger amount of organic solvent must be used compared with ordinary water-borne base coating composition.

JP 2005-7219A discloses a method for forming brilliant coating film comprising applying a metallic base coating composition (A) containing a solid content at coating time of 16-30 mass % at the first stage; applying a metallic base coating composition (B) containing a solid content at coating time of 5-15 mass %, which is formed by diluting the metallic base coating composition (A) with organic solvent, at the second stage; and further applying a clear coating composition; wet-on-wet in succession.

However, this coating film-forming method is liable to induce layer-mingling at the interface of the metallic base coat (A) and the metallic base coat (B) in the occasion of applying the metallic base coating composition (B) onto the metallic base coating composition (A) in the second stage, presumably due to the difference between the two coating films in solid concentration. This results in disturbance in orientation of the effect pigment in the vicinity of the interface to degrade the brilliance. Furthermore, this method is also subject to a problem that it heavily burdens the environments because the metallic base coating composition (B) contains a large amount of an organic solvent.

### DISCLOSURE OF THE INVENTION

A main object of the present invention is to provide a coating method of effect pigment-containing, water-borne base coating compositions, which can form brilliant multi-layered base coating film excelling in brilliance and surface smoothness.

We have engaged in concentrative studies for accomplishing the above object and now discovered: in the occasion of successively applying plural effect pigment-containing, water-borne base coating compositions onto a substrate, when a first effect pigment-containing, water-borne base coating composition having a relatively high solid content within a specific range and containing inorganic fine particles having an average primary particle diameter not more than 1 μm is used in combination with a second effect pigment-containing, water-borne base coating composition having a relatively low solid content within a specific range, infiltration of water from the second base coating film to the first base coating film is suppressed, and in consequence, mingling of the layers at the interface of the first base coating film and the second base coating film is markedly prevented, inducing less disturbance in orientation of effect pigments in the vicinity of the interface; and furthermore the effect pigment in the second base coating film is oriented in parallel with the substrate with greater ease, to form a brilliant multi-layered base coating film having excellent brilliance and surface smoothness. The present invention is whereupon completed.

Thus, the present invention provides a method for forming brilliant multi-layered coating film, which comprises the steps of

(1) applying an effect pigment-containing, water-borne base coating composition (A1) onto a substrate to form a first base coating film,

(2) applying an effect pigment-containing, water-borne base coating composition (A2) onto the uncured first base coating film to form a second base coating film, and

(3) heat-curing the two coating films, the method being characterized in that

(i) the effect pigment-containing, water-borne base coating composition (A1) has a solid content of not less than 15 mass % but less than 45 mass %;

(ii) the effect pigment-containing, water-borne base coating composition (A2) has a solid content of not less than 5 mass % but less than 15 mass %; and

(iii) the effect pigment-containing, water-borne base coating composition (A1) contains inorganic fine particles having an average primary particle diameter not more than 1 μm.

According to the method of the present invention, brilliant multi-layered coating film excelling in brilliance and surface smoothness can be formed using effect pigment-containing, water-borne base coating compositions. Therefore, such brilliant multi-layered coating film formed by the method of this invention is particularly useful for coating of automobile bodies.

The method of this invention is applicable to all industrial coating lines as earlier described in which different effect pigment-containing, water-borne base coating compositions are used in the first stage coating and second stage coating in a base coating zone, whereby forming on substrates coating films having very excellent brilliance.

In the present specification, “base coating film” signifies, where a top coating film formed on a substrate consists of multiple film layers, the coating film placed at the underlayer side. A top coating film is formed on a substrate with the view to impart excellent appearance (e.g., high color effect, high gloss, surface smoothness and the like) and weatherability. In particular, a brilliant top coating film is generally composed of a multi-layered coating film comprising effect pigment-containing base coating films exhibiting excellent color appearance and a clear coating film formed thereon, which has high gloss and excels in coating film performance such as surface smoothness and weatherability.

Hereinafter the brilliant multi-layered coating film-forming method of the invention is explained in further details.

According to the method of the invention, an effect pigment-containing, water-borne base coating composition (A1) is applied onto a substrate as the first step, to form a first base coating film. As the effect pigment-containing, water-borne base coating composition (A1), one having a solid content of not less than 15 mass % but less than 45 mass %, preferably not less than 20 mass % but less than 40 mass %, inter alia, not less than 25 mass % but less than 35 mass % can be used. Use of the effect pigment-containing, water-borne base coating composition (A1) having a solid content within the above-specified range enables to form brilliant coating film of excellent appearance, in particular, brilliant coating film having favorable brilliance and surface smoothness.

The substrate onto which the method of the invention is applicable is not subject to particular limitations. For example, outer panels of automobile bodies such as of passenger cars, trucks, motorcycles, buses and the like; car parts; and outer panels of household electric appliances such as mobile telephones, audio instruments and the like can be named. In particular, outer panels of automobile bodies and car parts are preferred.

Base materials constituting these substrates are subject to no particular limitation and, for example, metal sheet such as of iron, aluminum, brass, copper, stainless steel, tin plate, galvanized steel, alloyed zinc (Zn—Al, Zn—Ni, Zn—Fe and the like)-plated sheet steel and the like; plastic materials such as resins, e.g., polyethylene resin, polypropylene resin, acrylonitrile-butadiene-styrene (ABS) resin, polyamide resin, acrylic resin, vinylidene chloride resin, polycarbonate resin, polyurethane resin, epoxy resin and the like, and various FRP's; inorganic materials such as glass, cement, concrete and the like; timber; and fibrous materials (paper, fabric) and the like can be used. In particular, metal or plastic materials are suitable.

The substrate may be those made of above-described base materials on which an undercoating film or undercoating plus intermediate coating films are formed. Where the base material is a metal, preferably it is given a chemical conversion treatment with phosphate, chromate or the like in advance of forming undercoating film.

An undercoating film is formed for the purpose of imparting anti-corrosion property, rust preventive property, intimate adhesion to the base material or concealing ability of unevenness on the base material surface (occasionally referred to as “ground-concealing property”) to the substrate. As undercoating compositions for forming such undercoating film, those per se known can be used, for example, on conductive base materials such as metals, cationic or anionic electrodeposition coating compositions are preferred, and on low-polarity base materials such as polypropylene, use of chlorinated polyolefin resin-type coating compositions is preferred.

Undercoating compositions may be cured after their application by such means as heating or blasting, or may be dried to an extent not causing curing. Where a cationic or anionic electrodeposition coating composition is used as the undercoating composition, preferably the undercoating composition is heated after application to be cured, for preventing interlayer-mingling between the undercoating film and a coating film successively formed on the undercoating film and for forming a multi-layered coating film of favorable appearance.

An intermediate coating film is formed on the undercoating film, for the purpose of imparting intimate adhesion to undercoating film, ability to conceal color of the undercoating film (“color-concealing property”), ability to conceal unevenness on the undercoating film surface, anti-tipping property and the like.

An intermediate coating film can be formed by applying an intermediate coating composition. Its normally preferred film thickness is within a range of 10-50 μm, in particular, 15-30 μm, in terms of cured film thickness.

As intermediate coating compositions, those per se known can be used, for example, intermediate coating compositions comprising as the vehicle component a base resin such as hydroxyl-containing polyester resin hydroxyl-containing acrylic resin and the like, and a crosslinking agent such as melamine resin, blocked polyisocyanate and the like can be named.

Intermediate coating film is preferably cured or dried to such an extent that its drying can be sensed with finger touch, to prevent interlayer-mingling with the coating composition to be applied successively onto the intermediate coating film and to form a multi-layered coating film of excellent appearance.

Then, in the second stage, on the uncured first base coating film formed in the first stage, an effect pigment-containing, water-borne base coating composition (A2) is applied to form a second base coating film. As the effect pigment-containing, water-borne base coating composition (A2), one having a lower solid content relatively to the effect pigment-containing, water-borne base coating composition (A1), i.e., one having a solid content not less than 5 mass % but less than 15 mass %, preferably not less than 6 mass % but less than 12 mass %, inter alia, not less than 7 mass % but less than 10 mass % can be used.

Application of an effect pigment-containing, water-borne base coating composition onto the substrate can be conducted by the means known per se. For example, it can be applied with brush, but coating machines are generally used. As coating machines useful in such occasions, for example, rotary atomizing-type electrostatic coater, airless spray coater, air spray coater and the like can be named, rotary atomizing type electrostatic coater being particularly preferred. As a rotary bell atomizer, ABB Cartridge Bell Coater (tradename, ABB Co.) can be named. Also in coating lines for automobiles, paint cassette-type coater allowing easy switching of coating compositions, in particular, paint cassette-type rotary atomizing system electrostatic coater, is preferred.

Preferably, no pre-heating is conducted between the end of an effect pigment-containing, water-borne base coating composition (A1) application and initiation of an effect pigment-containing, water-borne base coating composition (A2) application, and an interval in the order of 30 seconds-3 minutes is provided.

The first base coating film preferably has a dry film thickness (T_{A1}) normally ranging 5-15 μm, in particular, 7-12 μm, and the second base coating film preferably has a dry film thickness (T_{A2}) normally ranging 1-5 μm, in particular, 2-4 μm. Again, it is normally preferred that the ratio of the dry film thickness (T_{A1}) of the first base coating film to dry film thickness (T_{A2}) of the second base coating film, T_{A1}/T_{A2}, is in the range of 1.5/1-5/1, in particular, 2/1-4/1.

In the present specification, dry film thickness of the first or second base coating film is a value measured with an electromagnetic film thickness gauge. For example, in the occasion of applying an effect pigment-containing, water-borne base coating composition (A1) onto a substrate in the first stage, the same coating composition is similarly applied onto a steel sheet (1); subsequently in the second stage, in the occasion of applying an effect pigment-containing, water-borne base coating composition (A2) onto the uncured first base coating film on the substrate, the same coating composition is similarly applied onto another steel sheet (2) different from the first steel sheet (1); and further in the third stage, simultaneously with heat-curing the first base coating film and the second base coating film on the substrate, the first base coating film on the steel sheet (1) and the second base coating film on the steel sheet (2) are heat-cured, and the dry film thickness of the first base coating film on the steel sheet (1) and that of the second base coating film on the steel sheet (2) are measured, to give the dry film thickness values.

According to the method of the present invention, a clear coating composition may be applied onto the second base coating film, where necessary. While such a clear coating composition can be applied after the first and second base coating films are heat-cured, and then heat-cured separately, it is generally preferred to apply the clear coating composition on uncured second base coating film and heat-cure the same. In that case, preferably a pre-heating is conducted at a temperature which will not cure the applied second base coating film, to dry the same film. A convenient pre-heating temperature ranges 50-100° C. and pre-heating time, from about 30 seconds to about 10 minutes, in particular, from about 1 to about 5 minutes. Application of a clear coating composition can be effected by any means known per se, for example, using a coating machine such as rotary atomizing system electrostatic coater, airless spray coater, air spray coater or the like.

Thus formed coating film can generally be cured by heating at about 100-about 180° C., preferably at about 120-about 160° C., for around 10-40 minutes. Whereupon a multi-layered coating film having excellent appearance can be obtained.

In the above-described method of the present invention, as effect pigment-containing, water-borne base coating compositions, water-borne coating compositions comprising water-soluble or water-dispersible base resin (a), curing agent (b) and effect pigment (c) can be used.

As the base resin (a), resins containing sufficient amount of hydrophilic groups for making the resin water-soluble or water-dispersible, and functional groups capable of cross-linking reaction with the curing agent (b), such as acrylic resin, polyester resin, alkyd resin, epoxy resin, polyurethane resin and the like, can be named, which can be used each singly or in combination of two or more. Of those, acrylic resin or polyester resin are preferred. As the hydrophilic groups, for example, carboxyl, hydroxyl, methylol, amino and sulfo groups, polyoxyethylene bond and the like can be named, among which carboxyl group is preferred. As the functional groups crosslinkable with curing agent (b), hydroxyl group is particularly preferred.

As the base resin (a), acrylic or polyester resin having carboxyl and hydroxyl groups are particularly preferred.

Where the base resin (a) has an ion-forming group such as carboxyl as the hydrophilic group, the resin can be water-solubilized or made water-dispersible by neutralizing said group with, for example, a basic substance or an acid. The base resin (a) can be made water-dispersible also by carrying out the polymerization to form the base resin (a), by emulsion-polymerizing the monomeric component(s) in the presence of a surfactant or a water-soluble high molecular compound. Liquid system in which resin particles in water-dispersed state are dispersed in an aqueous medium is generally referred to as “emulsion”, and in this specification also such a system wherein water-dispersible resin is dispersed in an aqueous medium is called an emulsion.

As the acrylic resin having carboxyl and hydroxyl groups, for example, an acrylic resin which is obtained by copolymerizing carboxyl-containing unsaturated monomer, hydroxyl-containing unsaturated monomer and other unsaturated monomer can be named. It is generally preferred for such an acrylic resin to have a number-average molecular weight ranging 3,000-100,000, in particular, 5,000-50,000. It is also normally preferred that the acrylic resin has an acid value ranging 10-150 mgKOH/g, in particular, 15-100 mgKOH/g.

In the present specification, number-average molecular weight and weight-average molecular weight of the resins such as acrylic resin, polyester resin, melamine resin and the like are the number-average or weight-average molecular weight measured with gel permeation chromatograph (“HLC 8120GPC”, tradename, Tosoh Corporation), as converted based on the number-average or weight-average molecular weight of polystyrene. Said gel permeation chromatograph is operated using four columns of “TSKgel G-4000 HXL”, “TSKgel G-3000 HXL”, “TSKgel G-2500 HXL” and “TSKgel G-2000 HXL” (tradenames, Tosoh Corporation), under the conditions of mobile phase=tetrahydrofuran, measuring temperature=40° C., flow rate=1 mL/min. and the detector=RI.

As the carboxyl-containing unsaturated monomers, for example, monocarboxylic acid such as (meth)acrylic acid, crotonic acid; dicarboxylic acid such as maleic acid, fumaric acid, itaconic acid; and half monoalkyl esterified products of these dicarboxylic acids can be named, which can be used each singly or in combination of two or more.

As the hydroxyl-containing unsaturated monomers, for example, C₁-C₂₄ hydroxyalkyl esters of (meth)acrylic acid such as 2-hydroxyethyl (meth)acrylate, 2- or 3-hydroxypropyl (meth)acrylate, 4-hydroxybutyl (meth)acrylate and the like can be named, which can be used either singly or in combination of two or more.

As the other unsaturated monomers, for example, C₁-C₂₄ alkyl esters or cycloalkyl esters such as methyl (meth)acrylate, ethyl (meth)acrylate, n- or i-propyl (meth)acrylate, n-, i- or t-butyl (meth)acrylate, 2-ethylhexyl (meth)acrylate, cyclohexyl (meth)acrylate, lauryl (meth)acrylate and the like; glycidyl (meth)acrylate, isobornyl (meth)acrylate, acrylonitrile, acrylamide, N,N′-dimethylaminoethyl methacrylate, N,N′-methylenebisacrylamide, styrene, vinyltoluene, vinyl acetate, vinyl chloride, 1,6-hexanediol diacrylate and the like can be named, which can be used either singly or in combination of two or more.

Copolymerization of above-named monomers can be carried out by those means known per se, for example, emulsion polymerization, solution polymerization or the like.

As the base resin (a), preferably at least one kind of water-dispersible acrylic resin which is obtained as above is used. In particular, multi-layer structured, particulate water-dispersible acrylic resin is advantageous. As the multi-layer structured, particulate water-dispersible acrylic resin, one prepared with use of, as a part of the unsaturated monomers for constituting the acrylic resin, amido-containing unsaturated monomer having at least two unsaturated groups per molecule is preferred; in particular, one prepared with use of, as a part of the unsaturated monomers for constituting the acrylic resin, amido-containing unsaturated monomer having at least two unsaturated groups per molecule and methacrylic acid is preferred for obtaining a coating film excelling in brilliance and water resistance.

Water-dispersible acrylic resin can be obtained by, for example, single stage or multi-stage emulsion polymerization of a mixture of above-described unsaturated monomers in the presence of a dispersion stabilizer such as a surfactant. In that occasion, a multi-layer-structured, particulate, water-dispersible acrylic resin can be obtained by carrying out the emulsion polymerization in multi-stages.

Carboxyl groups in acrylic resin can be neutralized with a basic substance where necessary, and whereupon the acrylic resin can be rendered water-dispersible. The neutralization is preferably conducted before mixing the resin with the curing agent (b), etc. The basic substance preferably is water-soluble, which can be, for example, ammonia, methylamine, ethylamine, propylamine, butylamine, dimethylamine, trimethylamine, triethylamine, ethylenediamine, morpholine, methylethanolamine, 2-(dimethylamino)ethanol, diethanolamine, triethanolamine, diisopropanolamine, 2-amino-2-methylpropanol and the like. They can be used each singly or in combination or two or more. Of these, 2-(dimethylamino)ethanol, diethanolamine and triethanolamine are particularly preferred.

As polyester resin containing carboxyl groups and hydroxyl groups, for example, those obtained by subjecting polyhydric alcohol, polyvalent carboxylic acid and still other compound(s) which may be used where necessary, to dehydrative condensation by per se known means can be named. It is generally preferred for the polyester resin to have number-average molecular weight ranging 500-50,000, in particular, 1,000-20,000. Again, normally the polyester resin preferably has an acid value within a range of 10-150 mgKOH/g, in particular, 15-100 mgKOH/g.

As the polyhydric alcohol, for example, ethylene glycol, diethylene glycol, propylene glycol, butanediol, pentanediol, 1,6-hexanediol, 2,2-dimethylpropanediol, glycerine, trimethylolpropane, pentaerythritol and the like can be used, which can be used either singly or in combination of two or more.

As the polyvalent carboxylic acid, for example, phthalic acid, isophthalic acid, terephthalic acid, tetrahydrophthalic acid, hexahydrophthalic acid, malonic acid, succinic acid, adipic acid, sebacic acid, trimellitic acid, pyromellitic acid and anhydrides thereof can be used, which can be used either singly or in combination of two or more.

As the other compounds which can be used where necessary, for example, lactones such as δ-butyrolactone, ε-caprolactone and the like; various saturated or unsaturated fatty acids as modifier, such as coconut oil fatty acid, tung oil fatty acid, soybean oil fatty acid, linseed oil fatty acid and the like; Cardura E 10P (tradename, monoepoxide having branched alkyl, Japan Epoxy Resin Co.) and the like can be used, which can be used either singly or in combination of two or more.

In the polyester resin, introduction of carboxyl groups can be effected by, for example, concurrently using, in the occasion of dehydrative condensation, polybasic acid such as trimellitic acid or pyromellitic acid having at least 3 carboxyl groups per molecule, as a part of the polyvalent carboxylic acid component; or by half ester addition of dicarboxylic acid to hydroxyl groups in hydroxyl-containing polyester resin. Introduction of hydroxyl groups can be conducted in the occasion of preparing the polyester resin, by concurrent use of polyhydric alcohol having at least 3 hydroxyl groups per molecule, such as glycerine, trimethylolpropane and the like, as a part of the polyhydric alcohol.

Polyester resin can be rendered water-dispersible by neutralization of carboxyl groups in the resin with above-described basic substance. The neutralization preferably is conducted before its mixing with the curing agent (b), etc.

Base resin (a) for the effect pigment-containing, water-borne base coating composition (A2) preferably contains, as at least a part thereof, at least one water-dispersible acrylic resin. It is particularly preferred that at least one of said water-dispersible acrylic resin contains, as an unsaturated monomer unit for constituting the acrylic resin, amido-containing unsaturated monomer unit having at least two radical-polymerizable unsaturated groups per molecule; inter alia, said at least one water-dispersible acrylic resin contains an amido-containing unsaturated monomer unit having at least two radical-polymerizable unsaturated groups per molecule, methacrylic acid unit and hydroxyl-containing unsaturated monomer unit; for forming coating film of excellent brilliance and water-resistance.

As the amido-containing unsaturated monomer having at least two radical-polymerizable unsaturated groups, for example, methylenebis (meth)acrylamide, ethylenebis (meth)acrylamide and the like can be named.

From the viewpoint of storage stability and water-resistance of the coating film, the water-dispersible acrylic resin preferably has an acid value within a range of 5-90 mg KOH/g, in particular, 10-70 mg KOH, inter alia, 15-50 mg KOH/g.

Also from the standpoint of water resistance and curability of the coating film formed therefrom, the water-dispersible acrylic resin preferably has a hydroxyl value within a range of 1-70 mgKOH/g, in particular, 2-60 mg KOH/g, inter alia, 5-50 mg KOH/g.

It is normally preferred for the water-dispersible acrylic resin to have an average particle diameter ranging 10-1,000 nm, in particular, 20-500 nm. In the present invention, the average particle diameter of water-dispersible acrylic resin is the value measured by coulter counter method at 20° C. This measurement can be conducted using, for example, COULTER N4 Model (Beckman Coulter Inc.).

As the curing agent (b), those known per se, for example, amino resin, blocked polyisocyanate compound and the like can be used, use of amino resin being preferred.

As the amino resin, for example, partially or wholly methylolated amino resin obtainable through reaction of an amino component such as melamine, urea, benzoguanamine, acetoguanamine, steroguanamine, spiroguanamine, dicyandiamide and the like with aldehyde can be named. As the aldehyde, formaldehyde, paraformaldehyde, acetaldehyde, benzaldehyde and the like can be named. Also such methylolated amino resin whose methylol groups are partially or completely etherified with suitable alcohol can be used, and as the alcohol useful for the etherification, for example, methyl alcohol, ethyl alcohol, n-propyl alcohol, i-propyl alcohol, n-butyl alcohol, i-butyl alcohol, 2-ethylbutanol, 2-ethylhexanol and the like may be named.

As the amino resin, melamine resin is preferred. In particular, at least one alkyl-etherified melamine resin selected from the group consisting of methyl-etherified melamine resin, butyl etherified melamine resin and methyl-butyl-mixed-etherified melamine resin is preferred, which are obtained by partially or completely etherifying methylol groups in methylolated melamine resin with methyl alcohol, butyl alcohol, or methyl alcohol and butyl alcohol, respectively.

The melamine resin to be blended with each of effect pigment-containing, water-borne base coating compositions (A1) and (A2) may be the same or different. As the melamine resin which can be blended with the effect pigment-containing, water-borne base coating composition (A1), one having weight-average molecular weight (M_{A1}) within a range of 800-5,000, in particular, 1,000-4,000 is preferred, and as that to be blended with the effect pigment-containing, water-borne base coating composition (A2), one having weight-average molecular weight (M_{A2}) within a range of 400-4,000, in particular, 600-3,000 is preferred.

It is furthermore preferred for the melamine resin to be blended with the effect pigment-containing, water-borne base coating composition (A1) to have a weight-average molecular weight (M_{A1}) greater than that (M_{A2}) of the melamine resin blended with the effect pigment-containing, water-borne base coating composition (A2) by 300-4,000, in particular, by 600-3,000, as such enables provision of brilliant coating film of excellent brilliance.

That is, use of an effect pigment-containing, water-borne base coating composition (A1) which contains an alkyl etherified melamine resin having a relatively large weight-average molecular weight and hence having a relatively high viscosity rise rate at the heat-curing time, in the first stage of the method of this invention, is effective for preventing interlayer mingling at the interface of the first base coating film with the second base coating film. Furthermore, use of an effect pigment-containing, water-borne base coating composition (A2) which contains an alkyl etherified melamine resin having relatively low weight-average molecular weight and hence having a relatively low viscosity rise rate at the heat-curing time in the second stage, can improve fluidability of the effect pigment in the second base coating film during the time from its application to curing and facilitates parallel orientation of the effect pigment to the substrate. It is presumed thus a brilliant base coating film can be formed.

When at least one alkyl etherified melamine resin selected from the group consisting of methyl etherified melamine resin, butyl etherified melamine resin and methyl-butyl mixed etherified melamine resin is used as the melamine resin to be blended with such effect pigment-containing, water-borne base coating composition (A1) and effect pigment-containing, water-borne base coating composition (A2), preferably the molar ratio R_{A1} (mol %) of the butyl group to the sum of mol numbers of methyl and butyl groups in the alkyl etherified melamine resin to be blended in the effect pigment-containing, water-borne base coating composition (A1) is greater than the molar ratio R_{A2} (mol %) of the butyl group to the sum of mol numbers of methyl and butyl groups in the alkyl etherified melamine resin to be blended in the effect pigment-containing, water-borne base coating composition (A2), by at least 30. Whereby brilliant base coating film excellent in brilliance can be obtained. It is particularly preferred that the alkyl etherified melamine resin which is blended in the effect pigment-containing, water-borne base coating composition (A1) is a methyl-butyl mixed etherified melamine resin and/or a butyl etherified melamine resin, and the alkyl etherified melamine resin to be blended in the effect pigment-containing, water-borne base coating composition (A2) is a methyl etherified melamine resin.

That is, by using in the first stage of the method of the present invention an effect pigment-containing, water-borne base coating composition (A1) which contains an alkyl etherified melamine resin having a relatively large molar ratio R_{A1} (mol %) of the butyl group to the sum of mol numbers of methyl and butyl groups and hence presumably having relatively high hydrophobicity, and by using in the second stage of the method of the present invention an effect pigment-containing, water-borne base coating composition (A2) which contains an alkyl etherified melamine resin having a relatively small molar ratio R_{A2} (mol %) of the butyl group to the sum of mol numbers of methyl and butyl groups and hence presumably having relatively high hydrophilicity, inter-layer mingling at the interface of the first base coating film and the second base coating film can be prevented. This is presumably the cause enabling formation of a brilliant base coating film having excellent brilliance.

In the present specification, the molar ratio R_{A} (mol %) of butyl group to the sum of mol numbers of methyl and butyl groups in an alkyl etherified melamine resin is a value calculated by measuring the molar ratio between methyl group and butyl group in the alkyl etherified melamine resin by NMR spectro-analysis. Thus, the molar ratio R_{A} (mol %) of butyl group to the sum of mol numbers of methyl and butyl groups in a methyl etherified melamine resin is 0, and that in a butyl etherified melamine resin is 100.

As blocked polyisocyanate compound which can be used as the curing agent (b), for example, polyisocyanate compounds having at least two isocyanate groups per molecule, whose isocyanate groups are blocked with a blocking agent such as oxime, phenol, alcohol, lactam, mercaptan, pyrazole and the like, can be named.

The ratio between the contents of such base resin (a) and curing agent (b) in the effect pigment-containing, water-borne base coating compositions useful for the present invention preferably lies within a range of 50-90 mass %, in particular, 60-85 mass %, of the former and 10-50 mass %, in particular, 15-40 mass %, of the latter, based on the total solid contents of the two components.

Effect pigment (c) encompasses pigments which impart to coating films glittering brilliance or interference of light rays, and which preferably are flaky or laminar. As effect pigment (c), for example, aluminum flake pigment, vapor-deposited aluminum flake pigment, metal oxide-coated aluminum flake pigment, colored aluminum flake pigment, mica, titanium oxide-coated mica, iron oxide-coated mica, micaceous iron oxide, titanium oxide-coated silica, titanium oxide-coated alumina, iron oxide-coated silica, iron oxide-coated alumina and the like can be named, which can be used either singly or in combination of two or more. An effect pigment which is used in an effect pigment-containing, water-borne base coating composition (A1) and that used in an effect pigment-containing, water-borne base coating composition (A2) may be the same or different.

Effect pigment (c) preferably has an average particle diameter within a range of 3-30 μm, in particular, 5-25 μm. In the present specification, average particle diameter of effect pigment (c) is median size (d 50) in volumetric particle size distribution as measured by laser diffraction scattering method, which can be measured, for example, with a microtrack particle size distribution measuring device “MT3300” (tradename, NIKKISO Co., Ltd.)

Those effect pigments (c) are also preferably given in advance a dispersing treatment with a treating agent containing phospho groups or sulfo groups, for suppressing hydrogen gas generation. As phospho or sulfo group-containing treating agent, per se known low molecular compound or polymer can be used.

The effect pigment-containing, water-borne base coating composition (A1) preferably contains such effect pigment (c) within a range of 1-30%, in particular, 5-20%, inter alia, 8-15% in terms of pigment mass concentration (%); and the effect pigment-containing, water-borne base coating composition (A2) preferably contains the effect pigment (c) within a range of 5-40%, in particular, 10-35%, inter alia, 15-30% in terms of pigment mass concentration (%). It is furthermore preferred that the ratio of the pigment mass concentration (P_{A1}) of effect pigment (c) which is contained in the effect pigment-containing, water-borne base coating composition (A1) to the pigment mass concentration (P_{A2}) of effect pigment (c) which is contained in the effect pigment-containing, water-borne base coating composition (A2), P_{A1}/P_{A2}, lies normally within a range of 1/5-1/1.1, in particular, 1/4.5-1/1.5, inter alia, 1/4.5-1/1.8. In the present specification, “pigment mass concentration (%)” of an effect pigment signifies the mass ratio of the effect pigment to the solid matter of the coating composition.

Effect pigment-containing, water-borne base coating composition (A1) contains, in addition to the effect pigment, inorganic fine particles having an average primary particle diameter of not more than 1 μm, in particular, 0.001-0.8 μm, inter alia, 0.01-0.08 μm. The average primary particle diameter of inorganic fine particles as referred to in this invention is an average value of maximum diameters of 20 inorganic fine particles present on a straight line drawn at random on an electron micrograph of each sample inorganic fine particulate powder as observed on scanning type electron microscope.

When effect pigment-containing, water-borne base coating composition (A1) contains such inorganic fine particles, inter-layer mingling at the interface of the first base coating film and second base coating film is more completely prevented to decrease disturbance in effect pigment's orientation in the vicinity of the interface, and achieves the effect of enabling formation of coating film excelling in brilliance. The mechanism of achieving such an effect is yet unclear, but it is presumed that the inorganic fine particles contained in effect pigment-containing, water-borne base coating composition (A1) suppress penetration and migration of water from the second base coating film to the first base coating film in the occasion of applying an effect pigment-containing, water-borne base coating composition (A2) to form the second base coating film on the first base coating film formed with such a composition (A1), and in consequence suppress inter-layer mingling at the interface of the first and second base coating films to reduce disturbance in effect pigments' orientation in the vicinity of the interface and to form a coating film excelling in brilliance.

Again in effect pigment-containing, water-borne base coating composition (A1), the pigment mass concentration (%) of the inorganic fine particles preferably lies within a range of 2-30, in particular, 5-20, inter alia, 7-17. In this specification, pigment mass concentration (%) of inorganic fine particles signifies the mass ratio of inorganic fine particles to the solid matter of the coating composition.

As inorganic fine particles which can be contained in effect pigment-containing, water-borne base coating composition (A1), for example, barium sulfate, barium carbonate, calcium carbonate, aluminum silicate, titanium oxide, silica, magnesium carbonate, talc, alumina white and the like can be named. Of those, barium sulfate, calcium carbonate and silica, inter alia, barium sulfate, are preferred.

As the barium sulfate, normally one having an average primary particle diameter within a range of 0.001-0.8 μm, in particular, 0.01-0.08 μm is preferred.

While effect pigment-containing, water-borne base coating composition (A2) in general preferably contains no inorganic fine particles, it may contain inorganic fine particles, in particular, barium sulfate fine particles, at a pigment mass concentration (%) preferably less than 25, in particular, within a range of 0.1-15, inter alia, 1-5. In that case, preferably the pigment mass concentration (%) of barium sulfate fine particles in effect pigment-containing, water-borne base coating composition (A1) is made higher than that of barium sulfate fine particles contained in effect pigment-containing, water-borne base coating composition (A2) by at least 5, in particular, by 10-20. Where the first base coating film positioned at the underlayer side of base coating film contains relatively larger amount of barium sulfate fine particles compared to the second base coating film, inter-layer mingling at the interface of the first and second base coating films can be effectively prevented.

Effect pigment-containing, water-borne base coating compositions to be used in the method of this invention may further contain, besides above effect pigment (c), where necessary, pigment such as coloring pigment, extender pigment and the like.

As coloring pigment, for example, white pigment such as titanium dioxide, black pigment such as carbon black, acetylene black, lamp black, bone black, graphite, black iron, aniline black and the like; yellow pigment such as yellow iron oxide, Titan Yellow, monoazo yellow, condensed azo yellow, azomethine yellow, bismuth vanadate, benzimidazole, isoindolinone, isoindoline, quinophthalone, benzidine yellow, Permanent Yellow and the like; orange pigment such as Permanent Orange; red pigment such as red iron oxide, Naphthol AS-azo red, anthanthrone, Anthraquinonyl Red, perilene maroon, quinacridone red pigment, diketopyrrolopyrrole, Watching Red, Permanent Red and the like; violet pigment such as cobalt violet, quinacridone violet, dioxazine violet and the like; blue pigment such as cobalt blue, phthalocyanine blue, threne blue and the like; and green pigment such as phthalocyanine green and the like can be named. As extender pigment, for example barium sulfate, barium carbonate, calcium carbonate, aluminum silicate, gypsum, clay, silica, white carbon, diatomaceous earth, talc, magnesium carbonate, alumina white, Gloss White, mica powder and the like can be named.

Effect pigment-containing, water-borne base coating compositions can furthermore be blended with other paint additives which are customarily used for formulation of water-borne paint, such as ultraviolet absorber, light stabilizer, surface treating agent, fine polymer particles, basic neutralizer, antiseptic agent, antirusting agent, silane coupling agent, pigment dispersant, antiprecipitant, thickener, defoaming agent, curing catalyst, water, organic solvent and the like.

Effect pigment-containing, water-borne base coating composition (A1) can have solid content of generally 15-less than 45 mass %, preferably 20-less than 40 mass %, inter alia, 25-less than 35 mass %; and effect pigment-containing, water-borne base coating composition (A2) can have a solid content of generally 5-less than 15 mass %, preferably 6-less than 12 mass %, inter alia, 7-less than 10 mass %. Furthermore, the ratio of solid content (S_{A1}) of effect pigment-containing, water-borne base coating composition (A1) to solid content (S_{A2}) of effect pigment-containing, water-borne base coating composition (A2), S_{A1}/S_{A2}, is normally within a range of 1.5/1-5/1, preferably 2.6/1-4.5/1, inter alia, 3/1-4/1. It is particularly advantageous that the solid content (S_{A1}) of effect pigment-containing, water-borne base coating composition (A1) is within a range of 20-39 mass %, the solid content (S_{A2}) of effect pigment-containing, water-borne base coating composition (A2) is 7-9 mass %, and the ratio of S_{A1}/S_{A2} is within a range of 2.6/1-4.5/1.

In the present specification, solid content of an effect pigment-containing, water-borne base coating composition is the mass ratio of non-volatile component remaining after drying the effect pigment-containing, water-borne base coating composition at 110° C. for an hour, which can be calculated by measuring out about 2 g of the effect pigment-containing, water-borne base coating composition into an aluminum foil cup of about 5 cm in diameter, spreading it well over the whole bottom area of the cup, drying it at 110° C. for an hour and determining its mass before and after the drying.

The effect pigment-containing, water-borne base coating composition can be prepared by dissolving or dispersing those constituent components as described in the foregoing in an aqueous medium according to customary practice. As the aqueous medium, normally water is used, while organic solvent may be concurrently used depending on the circumstances. In a mixed system of water and organic solvent, the water content is preferably at least 50 mass %, in particular, at least 65 mass %.

On the second base coating film formed as above, using above-described effect pigment-containing, water-borne base coating composition (A2), a clear coating composition can be applied as aforesaid. Such a clear coating composition can be applied onto heat-cured two coating films of the first and second base coating compositions and then heat-cured, but generally it is preferred to apply it on uncured second base coating film and heat-cure the first base coating film, the second coating film and the clear coating film simultaneously.

So formed coating film can be generally cured by heating at about 100-about 180° C., preferably about 120-about 160° C., for about 10-40 minutes, whereby providing a multi-layered coating film excelling in appearance (e.g., high color appearance, high gloss and surface smoothness).

As the clear coating composition, for example, those per se known and are customarily used for coating automobile bodies can be used. More specifically, for example, organic solvent-based thermosetting coating compositions, water-borne thermosetting coating compositions, thermosetting powder coating compositions and the like can be named, which contain main resin having crosslinking functional groups such as hydroxyl, carboxyl, epoxy, silanol and the like, such as acrylic resin, polyester resin, alkyd resin, urethane resin, epoxy resin, fluorinated resin and the like; and crosslinking agent as the vehicle component such as melamine resin, urea resin, optionally blocked polyisocyanate compound, carboxyl-containing compound or resin, epoxy-containing compound or resin and the like. Of these, organic solvent-based thermosetting coating composition or water-borne thermosetting coating composition containing carboxyl-containing resin and epoxy-containing resin are preferred. Clear coating composition may be in the form of one-package coating or two-package coating such as two-package type urethane resin coating composition.

The clear coating composition may also contain, to an extent not impairing its transparency, coloring pigment, effect pigment, dye and the like, and moreover suitably other additives such as extender pigment, ultraviolet absorber, defoaming agent, thickener, antirusting agent, surface-treating agent and the like.

Generally preferred thickness of the clear coating film is, in terms of dry film thickness, 15-60 μm, in particular, 20-50 μm, from the viewpoint of appearance of the coating film and coating operability.

### EXAMPLES

Hereinafter the invention is explained more specifically, referring to working examples. The invention, however, is in no way limited by these working examples in which parts and percentages are by mass.

### Production Examples of Acrylic Resin Emulsion (B)

### Production Example 1

A reactor equipped with a thermometer, thermostat, stirrer, reflux condenser and dropping device was charged with 100 parts of deionized water and 0.5 part of AQUALON KH-10^{(note 1)}, which were mixed by stirring in nitrogen gas current, and the temperature was raised to 80° C. Then 1% of the total amount of the following monomeric emulsion (1) and 10.3 parts of 3% aqueous ammonium persulfate solution were introduced into the reactor and kept at 80° C. for 15 minutes. Thereafter the rest of the monomeric emulsion (1) was dropped into the reactor over 3 hours, and aged for an hour after completion of the dropping. Then the monomeric emulsion (2) as specified in the following was dropped over 2 hours, followed by 1 hour's aging. Thereafter the reaction system was cooled to 30° C. while 42 parts of 5% aqueous 2-(dimethylamino)ethanol solution was slowly added to the reactor and the reaction product was discharged while being filtered with a 100-mesh nylon cloth, to provide an acrylic resin emulsion (B1) having an average particle diameter of 100 nm (as measured with a submicron particle size distribution measuring instrument, “COULTER N4 Model” (tradename, Beckmann-Coulter, Inc.) of a deionized water-diluted sample at 20° C.), acid value of 32 mgKOH/g, hydroxyl value of 48 mgKOH/g and solid content of 30%.
(note 1) AQUALON KH-10: tradename, polyoxyethylene alkyl ether sulfate ester ammonium salt, DAI-ICHI KOGYO SEIYAKU Co., Ltd.; active ingredient, 97%

Monomeric emulsion (1): Monomeric emulsion (1) was obtained by mixing with stirring 60 parts of deionized water, 1.0 part of AQUALON KH-10, 3 parts of methylenebisacrylamide, 4 parts of styrene, 13 parts of methyl methacrylate, 30 parts of ethyl acrylate and 20 parts of n-butyl acrylate.

Monomeric emulsion (2); Monomeric emulsion (2) was obtained by mixing with stirring 20 parts of deionized water, 0.5 part of AQUALON KH-10, 0.1 part of ammonium persulfate, 3 parts of styrene, 6 parts of methyl methacrylate, 2 parts of ethyl acrylate, 4 parts of n-butyl acrylate, 10 parts of 2-hydroxyethyl acrylate and 5 parts of methacrylic acid.

### Production Example 2

A reactor equipped with a thermometer, thermostat, stirrer, reflux condenser and dropping device was charged with 45 parts of deionized water and 0.5 part of AQUALON KH-10, which were mixed by stirring in nitrogen gas current, and the temperature was raised to 80° C. Then 1% of the total amount of the following monomeric emulsion (3) and 10.3 parts of 3% aqueous ammonium persulfate solution were introduced into the reactor and kept at 80° C. for 15 minutes. Thereafter the rest of the monomeric emulsion (3) was dropped into the reactor over 3 hours, and aged for an hour after completion of the dropping. Then the monomeric emulsion (4) as specified in the following was dropped over 2 hours, followed by 1 hour's aging. Thereafter the reaction system was cooled to 30° C. and the reaction product was discharged while being filtered with a 100-mesh nylon cloth, to provide an acrylic resin emulsion (B2) having an acid value of 32 mgKOH/g, hydroxyl value of 48 mgKOH/g and solid content of 48%.

Monomeric emulsion (3): Monomeric emulsion (3) was obtained by mixing with stirring 38 parts of deionized water, 1 part of AQUALON KH-10, 3 parts of methylenebisacrylamide, 4 parts of styrene, 13 parts of methyl methacrylate, 30 parts of ethyl acrylate and 20 parts of n-butyl acrylate.

Monomeric emulsion (4): Monomeric emulsion (4) was obtained by mixing with stirring 17 parts of deionized water, 0.5 part of AQUALON KH-10, 0.1 part of ammonium persulfate, 3 parts of styrene, 6 parts of methyl methacrylate, 2 parts of ethyl acrylate, 4 parts of n-butyl acrylate, 10 parts of 2-hydroxyethyl acrylate and 5 parts of methacrylic acid.

### Production Example 3

A reactor equipped with a thermometer, thermostat, stirrer, reflux condenser and dropping device was charged with 55 parts of deionized water and 0.5 part of AQUALON KH-10, which were mixed by stirring in nitrogen gas current, and the temperature was raised to 80° C. Then 1% of the total amount of the following monomeric emulsion (5) and 10.3 parts of 3% aqueous ammonium persulfate solution were introduced into the reactor and kept at 80° C. for 15 minutes. Thereafter the rest of the monomeric emulsion (5) was dropped into the reactor over 3 hours, and aged for an hour after completion of the dropping. Then the monomeric emulsion (6) as specified in the following was dropped over 2 hours, followed by 1 hour's aging. Thereafter the reaction system was cooled to 30° C. and the reaction product was discharged while being filtered with a 100-mesh nylon cloth, to provide an acrylic resin emulsion (B3) having an acid value of 32 mgKOH/g, hydroxyl value of 48 mgKOH/g and solid content of 43%.

Monomeric emulsion (5): Monomeric emulsion (5) was obtained by mixing with stirring 50 parts of deionized water, 1 part of AQUALON KH-10, 3 parts methylenebisacrylamide, 4 parts of styrene, 13 parts of methyl methacrylate, 30 parts of ethyl acrylate, and 20 parts of n-butyl acrylate.

Monomeric emulsion (6): Monomeric emulsion (6) was obtained by mixing with stirring 20 parts of deionized water, 0.5 part of AQUALON KH-10, 0.1 part of ammonium persulfate, 3 parts of styrene, 6 parts of methyl methacrylate, 2 parts of ethyl acrylate, 4 parts of n-butyl acrylate, 10 parts of 2-hydroxyethyl acrylate and 5 parts of methacrylic acid.

### Production Example 4

Production Example 1 was repeated except that the monomeric emulsion (1) was replaced with the following monomeric emulsion (7) and the monomeric emulsion (2), with the following monomeric emulsion (8), to provide an acrylic resin emulsion (B4) having an acid value of 44 mgKOH/g, hydroxyl value of 62 mgKOH/g and solid content of 30%.

Monomeric emulsion (7): Monomeric emulsion (7) was obtained by mixing with stirring 70 parts of deionized water, 1 part of AQUALON KH-10, 3 parts of methylenebisacrylamide, 2 parts of methacrylic acid, 5 parts of 2-hydroxyethyl acrylate, 4 parts of styrene, 12 parts of methyl methacrylate, 34 parts of ethyl acrylate and 20 parts of n-butyl acrylate.

Monomeric emulsion (8): Monomeric emulsion (8) was obtained by mixing with stirring 10 parts of deionized water, 0.5 part of AQUALON KH-10, 0.1 part of ammonium persulfate, 3 parts of styrene, 2 parts of ethyl acrylate, 2 parts of n-butyl acrylate, 8 parts of 2-hydroxyethyl acrylate and 5 parts of methacrylic acid.

### Production Example 5

Production Example 1 was repeated except that the monomeric emulsion (1) was replaced with the following monomeric emulsion (9) and the monomeric emulsion (2), with the following monomeric emulsion (10), to provide an acrylic resin emulsion (B5) having an acid value of 19 mgKOH/g, hydroxyl value of 24 mgKOH/g and solid content of 30%.

Monomeric emulsion (9): Monomeric emulsion (9) was obtained by mixing with stirring 55 parts of deionized water, 1 part of AQUALON KH-10, 3 parts of acrylamide, 10 parts of styrene, 20 parts of methyl methacrylate and 27 parts of n-butyl acrylate.

Monomeric emulsion (10): Monomeric emulsion (10) was obtained by mixing with stirring 25 parts of deionized water, 0.5 part of AQUALON KH-10, 0.1 part of ammonium persulfate, 10 parts of methyl methacrylate, 10 parts of ethyl acrylate, 12 parts of n-butyl acrylate, 5 parts of 2-hydroxyethyl acrylate and 3 parts of methacrylic acid.

### Production Examples of Acrylic Resin Solution

### Production Example 6

A reactor equipped with a thermometer, thermostat, stirrer, reflux condenser and dropping device was charged with 35 parts of ethylene glycol monobutyl ether whose temperature was then raised to 100° C. under stirring. Then a mixture of 30 parts of N-butyl acrylate, 17 parts of methyl methacrylate, 30 parts of 2-ethylhexyl methacrylate, 5 parts of styrene, 10 parts of 2-hydroxyethyl methacrylate, 8 parts of methacrylic acid and 1 part of azobisisobutyronitrile was dropped at a uniform rate over 4 hours with a dropping pump, while the temperature of 100° C. was maintained. After completion of the dropping, the temperature was maintained at 100° C. for a further hour, and stirring was continued. Then a solution of 0.5 part of 2.2′-azobis(2,4-dimethylvaleronitrile) as dissolved in 10 parts of ethylene glycol monobutyl ether was dropped at a uniform rate over an hour. Further maintaining the reaction system at 115° C. for an hour, an acrylic resin solution was obtained. After the end of the reaction, the solution was neutralized with the equivalent amount of 2-(dimethylamino)ethanol, and ethylene glycol monobutyl ether was added to provide an acrylic resin solution having a solid content of 55%.

### Formulation of Inorganic Fine Particle Dispersions (C)

### Production Example 7

In a paint conditioner, 180 parts of the acrylic resin solution as obtained in Production Example 6, 360 parts of deionized water, 6 parts of SURFYNOL 104 A (tradename; Air Products and Chemicals, Inc., a defoaming agent, solid content: 50%) and 250 parts of NEOLITE SP-300 (tradename; Takehara Kagaku Kogyo Co., Ltd., calcium carbonate powder, average primary particle diameter: 0.15 μm) were mixed and dispersed at room temperature for an hour with addition of glass beads medium, to provide an inorganic fine particle dispersion (C1).

### Production Example 8

In a paint conditioner, 180 parts of the acrylic resin solution as obtained in Production Example 6, 360 parts of deionized water, 6 parts of SURFYNOL 104 A (tradename; Air Products and Chemicals, Inc., a defoaming agent, solid content: 50%) and 250 parts of NEOLITE SP (tradename; Takehara Kagaku Kogyo Co., Ltd., calcium carbonate powder, average primary particle diameter: 0.08 μm) were mixed and dispersed at room temperature for an hour with addition of glass beads medium, to provide an inorganic fine particle dispersion (C2) having a particle size not greater than 10 μm.

### Production Example 9

In a paint conditioner, 100 parts of the acrylic resin solution as obtained in Production Example 6, 360 parts of deionized water, 6 parts of SURFYNOL 104 A (Air Products and Chemicals, Inc., a defoaming agent, solid content: 50%) and 80 parts of AEROSIL 200 (tradename; Nippon Aerosil Co., Ltd, silica powder, average primary particle diameter: 0.12 μm) were mixed and dispersed at room temperature for an hour with addition of glass beads medium, to provide an inorganic fine particle dispersion (C3).

### Production Example 10

In a paint conditioner, 100 parts of the acrylic resin solution as obtained in Production Example 6, 360 parts of deionized water, 6 parts of SURFYNOL 104 A (tradename; Air Products and Chemicals, Inc., a defoaming agent, solid content: 50%) and 80 parts of AEROSIL 380 (tradename, Nippon Aerosil Co., Ltd, silica powder, average primary particle diameter: 0.07 μm) were mixed and dispersed at room temperature for an hour with addition of glass beads medium, to provide an inorganic fine particle dispersion (C4).

### Production Example 11

In a paint conditioner, 180 parts of the acrylic resin solution as obtained in Production Example 6, 360 parts of deionized water, 6 parts of SURFYNOL 104 A (tradename; Air Products and Chemicals, Inc., a defoaming agent, solid content: 50%) and 250 parts of SPARWITE W-5HB (tradename; Wilbur-Ellis Co., barium sulfate powder, average primary particle diameter: 1.6 μm) were mixed and dispersed at room temperature for an hour with addition of glass beads medium, to provide an inorganic fine particle dispersion (C5).

### Production Example 12

In a paint conditioner, 180 parts of the acrylic resin solution as obtained in Production Example 6, 360 parts of deionized water, 6 parts of SURFYNOL 104 A (tradename; Air Products and Chemicals, Inc., a defoaming agent, solid content: 50%) and 250 parts of SACHTLEBEN MICRO (tradename; Wilbur-Ellis Co., barium sulfate powder, average primary particle diameter: 0.7 μm) were mixed and dispersed at room temperature for an hour with addition of glass beads medium, to provide an inorganic fine particle dispersion (C6).

### Production Example 13

In a paint conditioner, 180 parts of the acrylic resin solution as obtained in Production Example 6, 360 parts of deionized water, 6 parts of SURFYNOL 104 A (tradename; Air Products and Chemicals, Inc., a defoaming agent, solid content: 50%) and 250 parts of BARIACE B-34 (tradename; Sakai Chemical Industry Co., Ltd., barium sulfate powder, average primary particle diameter: 0.3 μm) were mixed and dispersed at room temperature for an hour with addition of glass beads medium, to provide an inorganic fine particle dispersion (C7).

### Production Example 14

In a paint conditioner, 180 parts of the acrylic resin solution as obtained in Production Example 6, 360 parts of deionized water, 6 parts of SURFYNOL 104 A (tradename; Air Products and Chemicals, Inc. a defoaming agent, solid content: 50%) and 250 parts of BARIFINE BF-1 (tradename; Sakai Chemical Industry Co. Ltd., barium sulfate powder, average primary particle diameter: 0.05 μm) were mixed and dispersed at room temperature for an hour with addition of glass beads medium, to provide an inorganic fine particle dispersion (C8).

### Production Example 15

In a paint conditioner, 180 parts of the acrylic resin solution as obtained in Production Example 6, 360 parts of deionized water, 6 parts of SURFYNOL 104 A (tradename; Air Products and Chemicals, Inc., a defoaming agent, solid content: 50%) and 250 parts of BARIFINE BF-20 (tradename; Sakai Chemical Industry Co., Ltd., barium sulfate powder, average primary particle diameter: 0.03 μm) were mixed and dispersed at room temperature for an hour with addition of glass beads medium, to provide an inorganic fine particle dispersion (C9).

### Formulation of Aluminum Pigment Paste Concentrate (D)

### Production Example 16

An agitation-mixing vessel was charged with a mixed solvent of 10 parts of ethylene glycol monobutyl ether and 25 parts of octanol, to which 10 parts of an aluminum pigment paste GX-180A (tradename; Asahi Kasei Metals Co., Ltd., metal content: 74%) and 3 parts of phospho group-containing resin solution^{(note 2)} were added and mixed by stirring to provide an aluminum pigment paste concentrate (D1).

(Note 2) Phospho Group-Containing Resin Solution:
A reactor equipped with a thermometer, thermostat, stirrer, reflux condenser and a dropping device was charged with a mixed solvent of 27.5 parts of methoxypropanol and 27.5 parts of isobutanol, heated to 110° C., and 121.5 parts of a mixture composed of 25 parts of styrene, 27.5 parts of n-butyl methacrylate, 20 parts of “Isostearyl Acrylate” (trade name, Osaka Organic Chemical Industry Co., Ltd., a branched higher alkyl acrylate), 7.5 parts of 4-hydroxybutyl acrylate, 15 parts of phospho group-containing polymerizable monomer^{(note 3)}, 12.5 parts of 2-methacryloyloxyethyl acid phosphate, 10 parts of isobutanol and 4 parts of t-butyl peroxyoctanoate was added to the mixed solvent consuming 4 hours. Further, a mixture of 0.5 part of t-butyl peroxyoctanoate and 20 parts of isopropanol was dropped over an hour. Thereafter the reaction system was stirred and aged for an hour to provide a phospho group-containing resin solution having a solid content of 50%. The acid value of this resin attributable to the phospho groups was 83 mgKOH/g, the hydroxyl value attributable to 4-hydroxybutyl acrylate was 29 mgKOH/g, and the weight-average molecular weight was 10,000.

(Note 3) Phospho Group-Containing Polymerizable Monomer
A reactor equipped with a thermometer, thermostat, stirrer, reflux condenser and a dropping device was charged with 57.5 parts of monobutylphosphoric acid and 41.1 parts of isobutanol, and into which 42.5 parts of glycidyl methacrylate was dropped while passing air over 2 hours, followed by an hour's stirring and aging. Then 59 parts isopropanol was added to provide a phospho group-containing polymerizable monomer solution having a solid content of 50%. Its acid value attributable to the phospho groups was 285 mgKOH/g.

### Production Example 17

An agitation-mixing vessel was charged with a mixed solvent of 10 parts of ethylene glycol monobutyl ether and 25 parts of octanol, into which 20 parts of an aluminum pigment paste GX-180A (Asahi Kasei Metals Co., Ltd, metal content; 74%) and 6 parts of the phospho group-containing resin solution were added, and mixed and stirred to provide an aluminum pigment paste concentrate (D2).

### Production Example 18

An agitation-mixing vessel was charged with a mixed solvent of 10 parts of ethylene glycol monobutyl ether and 25 parts of octanol, into which 30 parts of an aluminum pigment paste GX-180A and 9 parts of the phospho group-containing resin solution were added, and mixed and stirred to provide an aluminum pigment paste concentrate (D3).

### Production Example 19

An agitation-mixing vessel was charged with a mixed solvent of 10 parts of ethylene glycol monobutyl ether and 25 parts of octanol, into which 40 parts of an aluminum pigment paste GX-180A and 12 parts of the phospho group-containing resin solution were added, and mixed and stirred to provide an aluminum pigment paste concentrate (D4).

### Production Example 20

An agitation-mixing vessel was charged with a mixed solvent of 10 parts of ethylene glycol monobutyl ether and 25 parts of octanol, into which 50 parts of an aluminum pigment paste GX-180A and 15 parts of the phospho group-containing resin solution were added, and mixed and stirred to provide an aluminum pigment paste concentrate (D5).

### Production Example 21

An agitation-mixing vessel was charged with a mixed solvent of 10 parts of ethylene glycol monobutyl ether and 25 parts of octanol, into which 60 parts of an aluminum pigment paste GX-180A and 18 parts of the phospho group-containing resin solution were added, and mixed and stirred to provide an aluminum pigment paste concentrate (D6).

### Formulation of Polyester Resin Solution

### Production Example 22

A reactor equipped with a stirrer, reflux condenser, water separator and thermometer was charged with 109 parts of trimethylolpropane, 141 parts of 1,6-hexanediol, 126 parts of hexahydrophthalic anhydride and 120 parts of adipic acid, and the reaction mixture's temperature was raised, consuming 3 hours for raising it from 160° C. to 230° C., followed by 4 hours' condensation reaction at 230° C. Then 38.3 parts of trimellitic anhydride was added to the resulting condensation reaction product to add carboxyl groups thereto, and reacted at 170° C. for 30 minutes. Diluting the reaction liquid with octanol, a polyester resin solution (PE) having an acid value of 46 mgKOH/g, hydroxyl value of 150 mgKOH/g, weight-average molecular weight of 6,400 and a solid concentration of 70% was obtained.

### Preparation of Effect Pigment-Containing, Water-Borne Base Coating Compositions (A1)

### Production Example 23

Into an agitation-mixing vessel 48 parts of the aluminum pigment paste concentrate (D1) as obtained in Production Example 16 was thrown, and while stirring the same, 43 parts of melamine resin (E1) (a methyl-butyl mixed etherified melamine resin, weight-average molecular weight: 2,000; molar ratio of butyl group to the sum of mol numbers of methyl and butyl groups: 50 mol %; solid content: 70%) was added. Further continuing the stirring, 32 parts of the inorganic fine particle dispersion (C1) as obtained in Production Example 7 and 233 parts of the acrylic resin emulsion (B1) as obtained in Production Example 1 were added to the reactor and mixed. Adding 2-(dimethylamino)ethanol and deionized water to the resulting mixture and where necessary adjusting viscosity of the system with addition of SN Thickener 660T (tradename, SAN NOPCO Ltd., a urethane-associated thickener), an effect pigment-containing, water-borne base coating composition (A1-1) of pH 8.0, having a solid content of 29% was obtained.

### Production Examples 24-49

Using the kind and amount as indicated in the following Table 1 of acrylic resin emulsions, inorganic fine particle dispersions, aluminum pigment paste concentrates and melamine resins, and operating similarly to Production Example 23, effect pigment-containing, water-borne base coating compositions (A1-2) to (A1-27) were obtained, each having the solid content as indicated in the following Table 1.

### Production Example 50

Into an agitation-mixing vessel 48 parts of the aluminum pigment paste concentrate (D1) as obtained in Production Example 16 was thrown, and while stirring the same, 43 parts of melamine resin (E1) (a methyl-butyl mixed etherified melamine resin, weight-average molecular weight: 2,000; molar ratio of butyl group to the sum of mol numbers of methyl and butyl groups: 50 mol %; solid content: 70%) was added. Further continuing the stirring, 43 parts of the inorganic fine particle dispersion (C8) as obtained in Production Example 14, 117 parts of the acrylic resin emulsion (B1) as obtained in Production Example 1 and 50 parts of the polyester resin solution (PE) as obtained in Production Example 22 were added to the reactor and mixed. Adding 2-(dimethylamino)ethanol and deionized water to the resulting mixture, an effect pigment-containing, water-borne base coating composition (A1-28) of pH 8.0, having a solid content of 28% was obtained.

### Production Examples 51-55

Using the kind and amount as indicated in the following Table 1 of acrylic resin emulsions and polyester resin solutions, inorganic fine particle dispersions, aluminum pigment paste concentrates and melamine resins, and operating similarly to Production Example 50, effect pigment-containing, water-borne base coating compositions (A1-29) to (A1-33) were obtained, each having the solid content as indicated in the following Table 1.

TABLE 1

| | | Base Resin (a) | | | | | | | | | | | |
|---|---|---|---|---|---|---|---|---|---|---|---|---|---|
| | | | | | | | Polyester | | | | | | |
| | | Acrylic Resin | | | | | Resin | Inorganic Fine | | | | | |
| Production | Coating | Emulsion (B) | | | | | Solution | Particle Dispersion (C) | | | | | |
| Example | Composition | B1 | B2 | B3 | B4 | B5 | PE | C1 | C2 | C3 | C4 | C5 | C6 |
| 23 | A1-1 | 233 | | | | | | 32 | | | | | |
| 24 | A1-2 | 233 | | | | | | | 32 | | | | |
| 25 | A1-3 | 233 | | | | | | | | 68 | | | |
| 26 | A1-4 | 233 | | | | | | | | | 68 | | |
| 27 | A1-5 | 233 | | | | | | | | | | 32 | |
| 28 | A1-6 | 233 | | | | | | | | | | | 32 |
| 29 | A1-7 | 233 | | | | | | | | | | | |
| 30 | A1-8 | 233 | | | | | | | | | | | |
| 31 | A1-9 | 233 | | | | | | | | | | | |
| 32 | A1-10 | 233 | | | | | | | | | | | |
| 33 | A1-11 | | 149 | | | | | | | | | | |
| 34 | A1-12 | | | 163 | | | | | | | | | |
| 35 | A1-13 | 233 | | | | | | | | | | | |
| 36 | A1-14 | 233 | | | | | | | | | | | |
| 37 | A1-15 | 233 | | | | | | | | | | | |
| 38 | A1-16 | 233 | | | | | | | | | | | |
| 39 | A1-17 | 233 | | | | | | | | | | | |
| 40 | A1-18 | | | | 233 | | | | | | | | |
| 41 | A1-19 | | | | | 233 | | | | | | | |
| 42 | A1-20 | 233 | | | | | | | | | | | |
| 43 | A1-21 | 233 | | | | | | | | | | | |
| 44 | A1-22 | 233 | | | | | | | | | | | |
| 45 | A1-23 | 233 | | | | | | | | | | | |
| 46 | A1-24 | 233 | | | | | | | | | | | |
| 47 | A1-25 | 233 | | | | | | | | | | | |
| 48 | A1-26 | 233 | | | | | | | | | | | |
| 49 | A1-27 | 233 | | | | | | | | | | | |
| 50 | A1-28 | 117 | | | | | 50 | | | | | | |
| 51 | A1-29 | 117 | | | | | 50 | | | | | | |
| 52 | A1-30 | 117 | | | | | 50 | | | | | | |
| 53 | A1-31 | 117 | | | | | 50 | | | | | | |
| 54 | A1-32 | 117 | | | | | 50 | | | | | | |
| 55 | A1-33 | 117 | | | | | 50 | | | | | | |

| | | | | Aluminum | | | | | | |
|---|---|---|---|---|---|---|---|---|---|---|
| | | | | Pigment | | Curing Agent (b) | | | | |
| | | | | Paste | | Melamine Resin (E) | | | | |
| | Inorganic Fine | | | Concentrate | | | E2 | E3 | E4 | Solid |
| Production | Particle Dispersion (C) | | | (D) | | | (note | (note | (note | Content |
| Example | C7 | C8 | C9 | D1 | D2 | E1 | 4) | 5) | 6) | [%] |
| 23 | | | | 48 | | 43 | | | | 29 |
| 24 | | | | 48 | | 43 | | | | 29 |
| 25 | | | | 48 | | 43 | | | | 27 |
| 26 | | | | 48 | | 43 | | | | 27 |
| 27 | | | | 48 | | 43 | | | | 29 |
| 28 | | | | 48 | | 43 | | | | 29 |
| 29 | 32 | | | 48 | | 43 | | | | 28 |
| 30 | | 32 | | 48 | | 43 | | | | 28 |
| 31 | | | 32 | 48 | | 43 | | | | 27 |
| 32 | | | | 48 | | 43 | | | | 27 |
| 33 | | | 32 | 48 | | 43 | | | | 46 |
| 34 | | | 32 | 48 | | 43 | | | | 43 |
| 35 | | | 32 | 48 | | 43 | | | | 35 |
| 36 | | | 32 | 48 | | 43 | | | | 31 |
| 37 | | | 32 | 48 | | 43 | | | | 22 |
| 38 | | | 32 | 48 | | 43 | | | | 16 |
| 39 | | | 32 | 48 | | 43 | | | | 13 |
| 40 | | | 32 | 48 | | 43 | | | | 28 |
| 41 | | | 32 | 48 | | 43 | | | | 29 |
| 42 | | | 144 | 48 | | 43 | | | | 31 |
| 43 | | | 96 | 48 | | 43 | | | | 30 |
| 44 | | | 64 | 48 | | 43 | | | | 29 |
| 45 | | | 16 | 48 | | 43 | | | | 28 |
| 46 | | | 32 | 48 | | | 43 | | | 28 |
| 47 | | | 32 | 48 | | | | 43 | | 28 |
| 48 | | | 32 | 48 | | | | | 43 | 28 |
| 49 | | | 32 | | 61 | 43 | | | | 27 |
| 50 | | 32 | | 48 | | 43 | | | | 28 |
| 51 | | | 32 | 48 | | 43 | | | | 27 |
| 52 | | | 16 | 48 | | 43 | | | | 28 |
| 53 | | | 32 | 48 | | | 43 | | | 28 |
| 54 | | | 32 | 48 | | | | 43 | | 28 |
| 55 | | | 32 | 48 | | | | | 43 | 28 |

note 4
Melamine resin (E2): a methyl-butyl mixed etherified melamine resin; weight-average molecular weight, 2,000; molar ratio of butyl groups to the sum of mol numbers of methyl and butyl groups: 70 mol %; solid content: 70%.
note 5
Melamine resin (E3): a methyl-butyl mixed etherified melamine resin; weight-average molecular weight, 1,500; molar ratio of butyl groups to the sum of mol numbers of methyl and butyl groups: 70 mol %; solid content: 70%.
note 6
Melamine resin (E4): a methyl-butyl mixed etherified melamine resin; weight-average molecular weight, 1,200; molar ratio of butyl groups to the sum of mol numbers of methyl and butyl groups: 70 mol %; solid content: 70%.

### Preparation of Effect Pigment-Containing, Water-Borne Base Coating Composition (A2)

### Production Example 56

Into an agitation-mixing vessel, 100 parts of the aluminum pigment paste concentrate (D5) as obtained in Production Example 20 was thrown, and while stirring the same, 38 parts of melamine resin (E5) (a methyl-etherified melamine resin; weight-average molecular weight: 800; molar ratio of butyl group to the sum of mol numbers of methyl and butyl groups: 0 mol %; solid content: 80%) was added. Further continuing the stirring, 233 parts of the acrylic resin emulsion (B1) as obtained in Production Example 1 was added to the reactor and mixed. Adding PRIMAL ASE-60 (tradename: Rohm & Haas Co., a polyacrylic acid thickener), 2-(dimethylamino)ethanol and deionized water to the resulting mixture, an effect pigment-containing, water-borne base coating composition (A2-1) of pH 8.0, having a solid content of 9% was obtained.

### Production Examples 57-69

Using the kind and amount as indicated in the following Table 2 of acrylic resin emulsions, inorganic fine particle dispersions, aluminum pigment paste concentrates and melamine resins, and operating similarly to Production Example 56, effect pigment-containing, water-borne base-coating compositions (A2-2) to (A2-14) were obtained, each having the solid content as indicated in the following Table 2.

### Production Example 70

Into an agitation-mixing vessel, 100 parts of the aluminum pigment paste concentrate (D5) as obtained in Production Example 20 was thrown, and while stirring the same, 38 parts of melamine resin (E5) (a methyl-etherified melamine resin; weight-average molecular weight: 800; molar ratio of butyl group to the sum of mol numbers of methyl and butyl groups: 0 mol %; solid content: 80%) was added. Further continuing the stirring, 117 parts of the acrylic resin emulsion (B1) as obtained in Production Example 1 and 50 parts of the polyester resin solution (PE) as obtained in Production Example 22 were added to the reactor and mixed. Adding PRIMAL ASE-60 (tradename: Rohm & Haas Co., a polyacrylic acid thickener), 2-(dimethylamino)ethanol and deionized water to the resulting mixture, an effect pigment-containing, water-borne base coating composition (A2-15) of pH 8.0, having a solid content of 9% was obtained.

### Production Examples 71-73

Using the kind and amount as indicated in the following Table 2 of acrylic resin emulsions and polyester resin solutions, inorganic fine particle dispersions, aluminum pigment paste concentrates and melamine resins, and operating similarly to Production Example 70, effect pigment-containing, water-borne base coating compositions (A2-16) to (A2-18) were obtained, each having the solid content as indicated in the following Table 2.

### Production Example 74

Into an agitation-mixing vessel, 87 parts of the aluminum pigment paste concentrate (D5) as obtained in Production Example 20 was thrown, and while stirring the same, 38 parts of the melamine resin (E5) was added. Further continuing the stirring, 64 parts of the inorganic fine particle dispersion (C9) as obtained in Production Example 15 and 233 parts of the acrylic resin emulsion (B1) as obtained in Production Example 1 were added to the reactor and mixed. Adding PRIMALASE-60, 2-(dimethylamino)ethanol and deionized water to the resulting mixture, an effect pigment-containing, water-borne base coating composition (A2-19) of pH 8.0, having a solid content of 9% was obtained.

### Production Example 75

Production Example 74 was repeated except that 64 parts of the inorganic fine particle dispersion (C9) was replaced with 32 parts of the same dispersion (C9), to provide an effect pigment-containing, water-borne base coating composition (A2-20) of pH 8.0, having a solid content of 9%.

TABLE 2

| | | | | | | Inorganic | | | | | | | | | |
|---|---|---|---|---|---|---|---|---|---|---|---|---|---|---|---|
| | | Base Resin (a) | | | | Fine | | | | | | | | | |
| | | | | | Polyester | Particle | | | | | | Curing Agent (b) | | | |
| | | Acrylic Resin | | | Resin | Dispersion | Aluminum Pigment | | | | | Melamine Resin (E) | | | Solid |
| Production | Coating | Emulsion (B) | | | Solution | (C) | Paste Concentrate (D) | | | | | | E6 | E7 | Content |
| Example | Composition | B1 | B4 | B5 | PE | C9 | D2 | D3 | D4 | D5 | D6 | E5 | (note 7) | (note 8) | [%] |
| 56 | A2-1 | 233 | | | | | | | | 100 | | 38 | | | 9 |
| 57 | A2-2 | 233 | | | | | | | | 100 | | 38 | | | 17 |
| 58 | A2-3 | 233 | | | | | | | | 100 | | 38 | | | 13 |
| 59 | A2-4 | 233 | | | | | | | | 100 | | 38 | | | 11 |
| 60 | A2-5 | 233 | | | | | | | | 100 | | 38 | | | 7 |
| 61 | A2-6 | 233 | | | | | | | | 100 | | 38 | | | 4 |
| 62 | A2-7 | | 233 | | | | | | | 100 | | 38 | | | 9 |
| 63 | A2-8 | | | 233 | | | | | | 100 | | 38 | | | 9 |
| 64 | A2-9 | 233 | | | | | | | | 100 | | | 43 | | 9 |
| 65 | A2-10 | 233 | | | | | | | | 100 | | | | 38 | 9 |
| 66 | A2-11 | 233 | | | | | | | | | 114 | 38 | | | 9 |
| 67 | A2-12 | 233 | | | | | | | 88 | | | 38 | | | 9 |
| 68 | A2-13 | 233 | | | | | | 74 | | | | 38 | | | 9 |
| 69 | A2-14 | 233 | | | | | 61 | | | | | 38 | | | 9 |
| 70 | A2-15 | 117 | | | 50 | | | | | 100 | | 38 | | | 9 |
| 71 | A2-16 | 117 | | | 50 | | | | | 100 | | 38 | | | 11 |
| 72 | A2-17 | 117 | | | 50 | | | | | 100 | | | 43 | | 9 |
| 73 | A2-18 | 117 | | | 50 | | | | | 100 | | | | 38 | 9 |
| 74 | A2-19 | 233 | | | | 64 | | | | 100 | | 38 | | | 9 |
| 75 | A2-20 | 233 | | | | 32 | | | | 100 | | 38 | | | 9 |

note 7
Melamine resin (E6): a methyl-butyl mixed etherified melamine resin; weight-average molecular weight: 1,200; molar ratio of butyl groups to the sum of mol numbers of methyl and butyl groups: 30 mol %; solid content: 70%.
note 8
Melamine resin (E7): a methyl-butyl mixed etherified melamine resin; weight-average molecular weight: 800; molar ratio of butyl groups to the sum of mol numbers of methyl and butyl groups: 50 mol %; solid content: 80%.

### Production of Test Substrates

A 45 cm-long, 30 cm-wide and 0.8 mm-thick zinc phosphate-treated cold-drawn steel sheet was electrodeposition coated with ELECRON GP-10 (tradename, Kansai Paint Co., Ltd., a thermosetting epoxy resin cationic electrodeposition coating composition) to a dry film thickness of 20 μm, which was heated at 170° C. for 30 minutes and cured. Then an intermediate coating composition, AMILAC TP-65-2 (tradename, Kansai Paint, Co., Ltd., polyester resin-amino resin type organic solvent-based intermediate coating composition) was applied thereonto to a dry film thickness of 40 μm, which was cured by heating at 140° C. for 30 minutes, to provide a test substrate.

### Example 1

In a coating environment of temperature 23° C. and humidity 75%, on the above-described test substrate, the effect pigment-containing, water-borne base coating compositions (A1-1) as obtained in Production Example 23 was applied with a rotary bell atomizer, ABB Cartridge Bell Coater (tradename, ABB Co.), each to a dry film thickness as indicated in Table 3, to form first base coating film. After an interval of 1 minute, on the first base coating film formed on the test substrate, the effect pigment-containing, water-borne base coating composition (A2-1) as obtained in Production Example 56 was applied with a rotary bell atomizer, ABB Cartridge Bell Coater (tradename, ABB Co.), each to a dry film thickness as indicated in Table 3, to form second base coating film. After an interval of 2 minutes, the second base coating film was pre-heated at 80° C. for 3 minutes, and onto the uncured base coating film surface MAGICRON KINO-1200 (tradename, Kansai Paint Co., Ltd., acrylic resin organic solvent-based top clear coating composition) was applied to a dry film thickness of 40 μm. After an interval of 7 minutes, these coating films were simultaneously cured by heating at 140° C. for 30 minutes, to provide a test panel.

### Examples 2-42 and Comparative Examples 1-6

Effect pigment-containing, water-borne base coating compositions (A1-2)-(A1-33) were coated in various combinations to dry film thicknesses as indicated in Table 3 to form each first base coating film, and thereafter effect pigment-containing, water-borne base coating compositions (A2-1)-(A2-20) were applied to form second base coating films. Through operations identical with those in Example 1 in all other respects, test panels of Examples 2-42 and Comparative Examples 1-6 were prepared.

### Evaluation Tests

Results of coating film performance tests of each of the test panels as obtained in above Examples 1-42 and Comparative Examples 1-6, were as shown in Table 3.

Flip-flop property: As to each test panel, L values (value) at receiving angles of 15° and 110° were measured with a multi-angle spectrophotometer MA-68 (tradename, X-Rite Co.) and its FF property was calculated according to the following equation:

FFvalue=L value at receiving angle of 15°/L value at receiving angle of 110°.

The greater the FF value, the greater the variation in L value (value) according to observation angle (receiving angle), indicating favorable FF property.

Brilliance: Each test panel was visually observed at varied observation angles, and the panel's brilliance was evaluated according to the following standard:
\textcircled{•}: remarkable variation in metallic effect according to the angle of visual observation, excellent flip-flop property, nearly no metallic unevenness and very excellent brilliance
◯: slight metallic unevenness recognizable but remarkable variation in metallic effect according to the angle of visual observation, excellent flip-flop property and good brilliance
Δ: variation in metallic effect according to the angle of visual observation is moderate, flip-flop property slightly inferior and slightly inferior brilliance
x: variation in metallic effect according to the angle of visual observation small, inferior flip-flop property and brilliance.

Surface smoothness: Appearance of each test panel was evaluated by visual observation:
\textcircled{•}: very excellent surface smoothness
◯: excellent surface smoothness
Δ: slightly inferior surface smoothness
x: inferior surface smoothness

Initial adherability: Each of the multi-layered coating film on each test panel was incised with a cutter to the depth reaching the substrate, to make one-hundred (100) 2 mm×2 mm square incisions. An adhesive tape was stuck on the incised surface and then rapidly peeled off at 20° C. The number of square coating film remaining on each test panel was examined:
\textcircled{•}: 100 squares remained, and the edges of incisions with the cutter were smooth
◯: 100 square remained but minor peeling observed at the crossing points of the incisions with the cutter
Δ: 99-81 squares remained
x: 80 or less squares remained.

Water-resistant adherability: The test panels were immersed in 40° C. warm water for 10 days, withdrawn, dried at room temperature for 12 hours and were given the squares test similar to the above initial adherability test. The evaluation standard was same to that applied to the initial adherability test.

TABLE 3

| | | Effect Pigment-containing, Water-borne | | | | | | Effect Pigment-containing, Water-borne | | | |
|---|---|---|---|---|---|---|---|---|---|---|---|
| | | Base Coating Composition (A1) | | | | | | Base Coating Composition (A2) | | | |
| | | | Inorganic fine particle dispersion | | | | | | Inorganic fine particle dispersion | | |
| | | | (C) | | | | | | (C) | | |
| | | | | Inorganic fine particles | | | | | | Inorganic fine particles | |
| | | | | Average | | | | | | Average | |
| | | | | primary | Pigment | Solid | Dry film | Coating | | primary | Pigment |
| | | Coating | Disper- | particle | mass con- | content | thickness | compo- | Disper- | particle | mass con- |
| | | composition | sion | diameter [μm] | centration [%] | [%] | [μm] | sition | sion | diameter [μm] | centration [%] |
| Example | 1 | A1-1 | C1 | 0.15 | 8 | 29 | 12 | A2-1 | | — | |
| | 2 | A1-2 | C2 | 0.08 | 8 | 29 | 12 | A2-1 | | — | |
| | 3 | A1-3 | C3 | 0.012 | 8 | 27 | 12 | A2-1 | | — | |
| | 4 | A1-4 | C4 | 0.007 | 8 | 27 | 12 | A2-1 | | — | |
| | 5 | A1-6 | C6 | 0.7 | 8 | 29 | 10 | A2-1 | | — | |
| | 6 | A1-7 | C7 | 0.3 | 8 | 28 | 11 | A2-1 | | — | |
| | 7 | A1-8 | C8 | 0.05 | 8 | 28 | 11 | A2-1 | | — | |
| | 8 | A1-28 | C8 | 0.05 | 8 | 28 | 11 | A2-15 | | — | |
| | 9 | A1-9 | C9 | 0.03 | 8 | 27 | 12 | A2-1 | | — | |
| | 10 | A1-29 | C9 | 0.03 | 8 | 27 | 12 | A2-15 | | — | |
| | 11 | A1-12 | C9 | 0.03 | 8 | 43 | 12 | A2-1 | | — | |
| | 12 | A1-13 | C9 | 0.03 | 8 | 35 | 12 | A2-1 | | — | |
| | 13 | A1-14 | C9 | 0.03 | 8 | 31 | 12 | A2-1 | | — | |
| | 14 | A1-15 | C9 | 0.03 | 8 | 22 | 9 | A2-1 | | — | |
| | 15 | A1-16 | C9 | 0.03 | 8 | 16 | 8 | A2-1 | | — | |
| | 16 | A1-9 | C9 | 0.03 | 8 | 27 | 11 | A2-3 | | — | |
| | 17 | A1-9 | C9 | 0.03 | 8 | 27 | 12 | A2-4 | | — | |
| | 18 | A1-29 | C9 | 0.03 | 8 | 27 | 12 | A2-16 | | — | |
| | 19 | A1-9 | C9 | 0.03 | 8 | 27 | 12 | A2-5 | | — | |
| | 20 | A1-18 | C9 | 0.03 | 8 | 28 | 12 | A2-7 | | — | |
| | 21 | A1-19 | C9 | 0.03 | 8 | 29 | 12 | A2-8 | | — | |
| | 22 | A1-20 | C9 | 0.03 | 25 | 31 | 12 | A2-1 | | — | |
| | 23 | A1-21 | C9 | 0.03 | 19 | 30 | 12 | A2-1 | | — | |
| | 24 | A1-22 | C9 | 0.03 | 14 | 29 | 12 | A2-1 | | — | |
| | 25 | A1-23 | C9 | 0.03 | 4 | 28 | 12 | A2-1 | | — | |
| | 26 | A1-30 | C9 | 0.03 | 4 | 28 | 12 | A2-15 | | — | |
| | 27 | A1-22 | C9 | 0.03 | 14 | 29 | 12 | A2-19 | C9 | 0.03 | 12 |
| | 28 | A1-22 | C9 | 0.03 | 14 | 29 | 12 | A2-20 | C9 | 0.03 | 7 |
| | 29 | A1-24 | C9 | 0.03 | 8 | 28 | 12 | A2-9 | | — | |
| | 30 | A1-31 | C9 | 0.03 | 8 | 28 | 12 | A2-17 | | — | |
| | 31 | A1-25 | C9 | 0.03 | 8 | 28 | 12 | A2-9 | | — | |
| | 32 | A1-32 | C9 | 0.03 | 8 | 28 | 12 | A2-17 | | — | |
| | 33 | A1-26 | C9 | 0.03 | 8 | 28 | 12 | A2-9 | | — | |
| | 34 | A1-33 | C9 | 0.03 | 8 | 28 | 12 | A2-17 | | — | |
| | 35 | A1-9 | C9 | 0.03 | 8 | 27 | 12 | A2-10 | | — | |
| | 36 | A1-29 | C9 | 0.03 | 8 | 27 | 12 | A2-18 | | — | |
| | 37 | A1-16 | C9 | 0.03 | 8 | 16 | 5 | A2-1 | | — | |
| | 38 | A1-9 | C9 | 0.03 | 8 | 27 | 12 | A2-11 | | — | |
| | 39 | A1-27 | C9 | 0.03 | 8 | 27 | 12 | A2-1 | | — | |
| | 40 | A1-27 | C9 | 0.03 | 8 | 27 | 12 | A2-12 | | — | |
| | 41 | A1-27 | C9 | 0.03 | 8 | 27 | 12 | A2-13 | | — | |
| | 42 | A1-27 | C9 | 0.03 | 8 | 27 | 12 | A2-14 | | — | |
| Comparative | 1 | A1-10 | | — | | 27 | 11 | A2-1 | | — | |
| Example | 2 | A1-5 | C5 | 1.6 | 8 | 29 | 11 | A2-1 | | — | |
| | 3 | A1-11 | C9 | 0.03 | 8 | 46 | 11 | A2-1 | | — | |
| | 4 | A1-17 | C9 | 0.03 | 8 | 13 | 7 | A2-1 | | — | |
| | 5 | A1-9 | C9 | 0.03 | 8 | 27 | 12 | A2-2 | | — | |
| | 6 | A1-9 | C9 | 0.03 | 8 | 27 | 12 | A2-6 | | — | |

| | |
|---|---|
| Effect Pigment-containing, Water-borne | |
| Base Coating Composition (A2) | Evaluation |

| | | Solid | Dry film | | | | | Water- |
|---|---|---|---|---|---|---|---|---|
| | | content | thickness | FF | | | Initial | resistant |
| | | [%] | [μm] | value | Brilliance | Surface smoothness | adherability | adherability |
| Example | 1 | 9 | 3 | 4.3 | ◯ | ◯ | ⊚ | ⊚ |
| | 2 | 9 | 3 | 4.5 | ◯ | ◯ | ⊚ | ⊚ |
| | 3 | 9 | 3 | 4.5 | ◯ | ◯ | ⊚ | ⊚ |
| | 4 | 9 | 3 | 4.3 | ◯ | ◯ | ⊚ | ⊚ |
| | 5 | 9 | 3 | 4.8 | ◯ | ◯ | ⊚ | ⊚ |
| | 6 | 9 | 3 | 5.0 | ◯ | ◯ | ⊚ | ⊚ |
| | 7 | 9 | 3 | 5.4 | ⊚ | ◯ | ⊚ | ⊚ |
| | 8 | 9 | 3 | 5.5 | ⊚ | ⊚ | ⊚ | ⊚ |
| | 9 | 9 | 3 | 5.6 | ⊚ | ⊚ | ⊚ | ⊚ |
| | 10 | 9 | 3 | 5.7 | ⊚ | ⊚ | ⊚ | ⊚ |
| | 11 | 9 | 3 | 4.6 | ◯ | ◯ | ⊚ | ⊚ |
| | 12 | 9 | 3 | 4.9 | ◯ | ◯ | ⊚ | ⊚ |
| | 13 | 9 | 3 | 5.5 | ⊚ | ⊚ | ⊚ | ⊚ |
| | 14 | 9 | 3 | 4.8 | ◯ | ⊚ | ⊚ | ⊚ |
| | 15 | 9 | 3 | 4.4 | ◯ | ⊚ | ⊚ | ⊚ |
| | 16 | 13 | 3 | 4.5 | ◯ | ◯ | ⊚ | ⊚ |
| | 17 | 11 | 3 | 4.9 | ◯ | ◯ | ⊚ | ⊚ |
| | 18 | 11 | 3 | 5.0 | ◯ | ⊚ | ⊚ | ⊚ |
| | 19 | 7 | 2 | 5.1 | ◯ | ◯ | ⊚ | ⊚ |
| | 20 | 9 | 3 | 5.5 | ◯ | ◯ | ⊚ | ⊚ |
| | 21 | 9 | 3 | 5.2 | ◯ | ◯ | ⊚ | ◯ |
| | 22 | 9 | 3 | 4.9 | ◯ | ◯ | ⊚ | ⊚ |
| | 23 | 9 | 3 | 5.1 | ◯ | ◯ | ⊚ | ⊚ |
| | 24 | 9 | 3 | 5.5 | ⊚ | ◯ | ⊚ | ⊚ |
| | 25 | 9 | 3 | 4.9 | ◯ | ◯ | ⊚ | ⊚ |
| | 26 | 9 | 3 | 5.0 | ◯ | ⊚ | ⊚ | ⊚ |
| | 27 | 9 | 3 | 4.8 | ◯ | ◯ | ⊚ | ⊚ |
| | 28 | 9 | 3 | 4.9 | ◯ | ◯ | ⊚ | ⊚ |
| | 29 | 9 | 3 | 5.3 | ⊚ | ◯ | ⊚ | ⊚ |
| | 30 | 9 | 3 | 5.4 | ⊚ | ⊚ | ⊚ | ⊚ |
| | 31 | 9 | 3 | 4.9 | ◯ | ◯ | ⊚ | ⊚ |
| | 32 | 9 | 3 | 5.0 | ◯ | ⊚ | ⊚ | ⊚ |
| | 33 | 9 | 3 | 4.7 | ◯ | ◯ | ⊚ | ⊚ |
| | 34 | 9 | 3 | 4.7 | ◯ | ⊚ | ⊚ | ⊚ |
| | 35 | 9 | 3 | 4.8 | ◯ | ◯ | ⊚ | ⊚ |
| | 36 | 9 | 3 | 4.9 | ◯ | ⊚ | ⊚ | ⊚ |
| | 37 | 9 | 5 | 4.2 | ◯ | ◯ | ⊚ | ⊚ |
| | 38 | 9 | 3 | 4.8 | ◯ | ◯ | ⊚ | ◯ |
| | 39 | 9 | 3 | 5.2 | ⊚ | ◯ | ⊚ | ⊚ |
| | 40 | 9 | 3 | 5.4 | ⊚ | ◯ | ⊚ | ⊚ |
| | 41 | 9 | 3 | 4.8 | ◯ | ◯ | ⊚ | ⊚ |
| | 42 | 9 | 3 | 4.3 | ◯ | ◯ | ⊚ | ⊚ |
| Comparative | 1 | 9 | 3 | 3.8 | Δ | ◯ | ⊚ | ⊚ |
| Example | 2 | 9 | 3 | 4.3 | ◯ | Δ | ⊚ | ⊚ |
| | 3 | 9 | 3 | 4.4 | ◯ | X | ⊚ | ⊚ |
| | 4 | 9 | 3 | 3.7 | Δ | ◯ | ⊚ | ⊚ |
| | 5 | 17 | 3 | 3.8 | Δ | ◯ | ⊚ | ⊚ |
| | 6 | 4 | 2 | 3.8 | Δ | ◯ | ⊚ | ⊚ |

1. A method for forming brilliant multi-layered coating film, which comprises the steps of
(1) applying an effect pigment-containing, water-borne base coating composition (A1) onto a substrate to form a first base coating film,
(2) applying an effect pigment-containing, water-borne base coating composition (A2) onto the uncured first base coating film to form a second base coating film, and
(3) heat-curing the two coating films, and wherein:
(i) the effect pigment-containing, water-borne base coating composition (A1) has a solid content of not less than 15 mass % but less than 45 mass %;
(ii) the effect pigment-containing, water-borne base coating composition (A2) has a solid content of not less than 5 mass % but less than 15 mass %; and
(iii) the effect pigment-containing, water-borne base coating composition (A1) contains inorganic fine particles having an average primary particle diameter not more than 1 μm.

2. A method according to claim 1, in which the effect pigment-containing, water-borne base coating composition (A1) has a solid content of not less than 20 mass % but less than 40 mass %.

3. A method according to claim 1, in which the effect pigment-containing, water-borne base coating composition (A2) has a solid content of not less than 6 mass % but less than 12 mass %.

4. A method according to claim 1, in which the pigment mass concentration of the inorganic fine particles is within a range of 2-30%.

5. A method according to claim 1, in which the inorganic fine particles are fine particles of barium sulfate.

6. A method according to claim 1, in which the effect pigment-containing, water-borne base coating composition (A1) and effect pigment-containing, water-borne base coating composition (A2) contain barium sulfate fine particles having an average primary particle diameter not greater than 1 μm, and the pigment mass concentration (%) of the barium sulfate fine particles contained in the effect pigment-containing, water-borne base coating composition (A1) is higher than the pigment mass concentration (%) of the barium sulfate fine particles contained in the effect pigment-containing, water-borne base coating composition (A2) by at least 5.

7. A method according to claim 1, in which the effect pigment-containing, water-borne base coating composition (A1) and effect pigment containing, water-borne base coating composition (A2) are water-borne coating compositions comprising water-soluble or water-dispersible base resin (a), curing agent (b) and effect pigment (c).

8. A method according to claim 7, in which the base resin (a) is acrylic resin or polyester resin containing carboxyl groups and hydroxyl groups.

9. A method according to claim 8, in which the effect pigment (c) is contained within a range of 2-50 mass parts per 100 mass parts of the combined solid contents of the base resin (a) and the curing agent (b).

10. A method according to claim 7, in which the effect pigment-containing, water-borne base coating composition (A1) contains the effect pigment (c) at a pigment mass concentration of 1-30%.

11. A method according to claim 7, in which the effect pigment-containing, water-borne base coating composition (A2) contains the effect pigment (c) at a pigment mass concentration of 5-40%.

12. A method according to claim 7, in which the ratio between the pigment mass concentration (P_{A1}) of effect pigment (c) contained in the effect pigment-containing, water-borne base coating composition (A1) and the pigment mass concentration (P_{A2}) of effect pigment (c) contained in the effect pigment-containing, water-borne base coating composition (A2), P_{A1}/P_{A2}, is within a range of 1/5-1/1.1.

13. A method according to claim 7, in which the curing agent (b) is amino resin, in particular, melamine resin.

14. A method according to claim 1 or 6, in which the effect pigment-containing, water-borne base coating compositions (A1) and (A2) contain melamine resin, the weight-average molecular weight (M_{A1}) of the melamine resin contained in the effect pigment-containing, water-borne base coating composition (A1) is within a range of 800-5,000; the weight-average molecular weight (M_{A2}) of the melamine resin contained in the effect pigment-containing, water-borne base coating composition (A2) is within a range of 400-4,000; and the weight-average molecular weight (M_{A1}) of the melamine resin contained in the effect pigment-containing, water borne base coating composition (A1) is larger than the weight-average molecular weight (M_{A2}) of the melamine resin contained in the effect pigment-containing, water-borne base coating composition (A2) by 300-4,000.

15. A method according to claim 1 or 6, in which the effect pigment-containing, water-borne base coating compositions (A1) and (A2) contain at least one kind of alkyl etherified melamine resin selected from the group consisting of methyl etherified melamine resin, butyl etherified melamine resin, and methyl-butyl mixed etherified melamine resin; and the molar ratio (mol %) of the butyl group to the sum of mol numbers of methyl and butyl groups in the alkyl etherified melamine resin contained in the effect pigment-containing, water-borne base coating composition (A1) is greater than the molar ratio (mol %) of the butyl group to the sum of mol numbers of the methyl and butyl groups in the alkyl etherified melamine resin contained in the effect pigment-containing, water-borne base coating composition (A2) by at least 30.

16. A method according to claim 1 or 6, in which the effect pigment-containing, water-borne base coating compositions (A1) and (A2) contain alkyl etherified melamine resins, the alkyl etherified melamine resin contained in the effect pigment-containing, water-borne base coating composition (A1) being methyl-butyl mixed etherified melamine resin and/or butyl etherified melamine resin, and that contained in the effect pigment-containing, water-borne base coating composition (A2) being methyl etherified melamine resin.

17. A method according to claim 1, in which the radio, S_{A1}/S_{A2}, of the solid content (S_{A1}) of the effect pigment-containing, water-borne base coating composition (A1) to the solid content (S_{A2}) of the effect pigment-containing, water-borne base coating composition (A2) ranging 1.5/1-5/1.

18. A method according to claim 1 or 6, in which the solid content (S_{A1}) of the effect pigment-containing, water-borne base coating composition (A1) is within a range of 20-39 mass % and the solid content (S_{A2}) of the effect pigment-containing, water-borne base coating composition (A2) is within a range of 7-9 mass %, the ratio, S_{A1}/S_{A2}, of the solid content (S_{A1}) of the effect pigment-containing, water-borne base coating composition (A1) to the solid content (S_{A2}) of the effect pigment-containing, water-borne base coating composition (A2) ranging 2.6/1-4.5/1.

19. A method according to claim 1, in which the ratio, T_{A1}/T_{A2}, of the dry film thickness (T_{A1}) of the coating film formed of the effect pigment-containing, water-borne base coating composition (A1) to the dry film thickness (T_{A2}) of the coating film formed of the effect pigment-containing, water-borne base coating composition (A2) is within a range of 1.5/1-5/1.

20. A method according to claim 19, in which the dry film thickness of the coating film formed of the effect pigment-containing, water-borne base coating composition (A1) is within a range of 5-15 μm, and that of the coating film formed of the effect pigment-containing, water-borne base coating composition (A2) is within a range of 1-5 μm.

21. A method according to claim 1, in which the substrate is a car body on which electrodeposition coating and intermediate coating have been applied by the order stated.

22. A method according to claim 1, comprising applying a clear coating composition onto uncured second base coating film, and thereafter heating to cure the first base coating film, the second base coating film and the clear coating film simultaneously.

23. Articles on which brilliant multi-layered coating film is formed by the method of claim 22.

24. A method according to claim 14, in which the solid content (S_{A1}) of the effect pigment-containing, water-borne base coating composition (A1) is within a range of 20-39 mass % and the solid content (S_{A2}) of the effect pigment-containing, water-borne base coating composition (A2) is within a range of 7-9 mass %, the ratio, S_{A1}/S_{A2}, of the solid content (S_{A1}) of the effect pigment-containing, water-borne base coating composition (A1) to the solid content (S_{A2}) of the effect pigment-containing, water-borne base coating composition (A2) ranging 2.6/1-4.5/1.

25. A method according to claim 15, in which the solid content (S_{A1}) of the effect pigment-containing, water-borne base coating composition (A1) is within a range of 20-39 mass % and the solid content (S_{A2}) of the effect pigment-containing, water-borne base coating composition (A2) is within a range of 7-9 mass %, the ratio, S_{A1}/S_{A2}, of the solid content (S_{A1}) of the effect pigment-containing, water-borne base coating composition (A1) to the solid content (S_{A2}) of the effect pigment-containing, water-borne base coating composition (A2) ranging 2.6/1-4.5/1.

26. A method according to claim 16, in which the solid content (S_{A1}) of the effect pigment-containing, water-borne base coating composition (A1) is within a range of 20-39 mass % and the solid content (S_{A2}) of the effect pigment-containing, water-borne base coating composition (A2) is within a range of 7-9 mass %, the ratio, S_{A1}/S_{A2}, of the solid content (S_{A1}) of the effect pigment-containing, water-borne base coating composition (A1) to the solid content (S_{A2}) of the effect pigment-containing, water-borne base coating composition (A2) ranging 2.6/1-4.5/1.
